(19) United States
(12) Patent Application Publication
(10) Pub. No.: US 2007/0143291 A1
(43) Pub. Date: Jun. 21, 2007

(54) Utilizing component targets in defining roles in a distributed and integrated system or systems

(75) Inventor: Michael E. Browne, Staatsbury, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: International Business Machines Corporation, Armonk, NY (US)

(21) Appl. No.: 11/314,286

(22) Filed: Dec. 21, 2005

(51) Int. Cl. G06F 17/30

(52) U.S. Cl. 707/9

(57) ABSTRACT

Disclosed are methods of and systems for creating roles on a centralized management server that include one to many authorizations for a given identity as well as the component targets they will be authorized for. The authorizations are defined based on the intersection of the task and the component for which it will act on. This combined authorization is then associated with specific identities. When a task is to be initiated, the central management server determines if the identity has been authorized for that task and for which components it can execute that task against. The infrastructure then generates the appropriate sub commands and only executes those sub commands against the authorized components contained in the list of requested components from the initiation request.

### BACKGROUND OF THE INVENTION

1. Field of the Invention

This invention generally relates to distributed computer systems, and more specifically, the invention relates to methods and systems for defining roles in such systems.

2. Background Art

In distributed or integrated computer systems in a server consolidation environment like computer clusters or BladeCenters and BladeCenters within larger computer clusters, there is a need for separation of duties due to various industry practices and regulatory requirements. This separation of duties is often compromised when central management servers or modules are architected. In the current practice, the industry generally defines roles for various authenticated users or identities in the entire cluster. The cluster management operations via the central management server, then provide access across all the components in the entire cluster and can perform cluster wide authorized tasks.

The cluster is considered the security realm for most tasks. The industry has utilized the concept of not defining the instance of the user or identity on a particular component to resolve this issue. This requires excessive management tasks by the customer to remove the identities from the desired components and in some cases limits the use of the system. For example, the customer may have to generate access control lists (ACLs) or protective mechanisms on each individual resource in each component throughout the cluster to restrict access to a particular resource on a subset of targets.

### SUMMARY OF THE INVENTION

An object of this invention is to improve distributed computer systems.

Another object of the present invention is to allow server and computer network resource consumption to be reduced by executing a smaller number of commands.

A further object of the invention is to allow one role definition on a central management server or module of a distributed computer system to enforce access to components of the system.

An object of the invention is to provide the ability to subset access to some components of a distributed computer system by constructing roles that are an intersection of an authorized task and the target of the task.

These and other objectives are attained, in accordance with the present invention, by creating roles on a centralized management server that include one to many authorizations for a given identity as well as the component targets they will be authorized for. The authorizations are defined based on the intersection of the task and the component for which it will act on. This combined authorization is then associated with specific identities. When a task is to be initiated, the central management server determines if the identity has been authorized for that task and for which components it can execute that task against. The infrastructure then generates the appropriate sub commands and only executes those sub commands against the authorized components contained in the list of requested components from the initiation request. No execution attempt is made against requested components that were not in the authorization list for that task associated with the requesting identity.

The ability to subset access to some components by constructing roles that are an intersection of the authorized task and the target of the task allows one role definition on the central management server or module to enforce the access, versus the customer having to generate ACL (access control lists) or protection mechanisms on each individual resource in each component through out the cluster.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a clustered computer system environment in which the present invention may be implemented.

FIG. 2 shows function stacks for a node and for a central management server of the computer cluster of FIG. 1.

FIG. 3 shows the security officer tasks performed in a first part of a preferred procedure for practicing this invention.

FIGS. 4 and 5 illustrate an example of the administrative tasks that may be performed in a second part of a preferred procedure for carrying out the present invention.

FIGS. 6 and 7 show another example of administrative tasks that may be performed in the second part of a preferred procedure for implementing the invention.

### DETAILED DESCRIPTION OF THE PREFERRED EMBODIMENTS

FIG. 1 shows a common clustered system environment. This environment includes a centralized management server 100, preferably an IBM Cluster Management Server (CMS), and a set of nodes 101, 102, 103 in the cluster, preferably these nodes are IBM P-Series servers. These nodes are typically the target of a management task. FIG. 1 also shows a network switch, cable plant and protocol stack, referenced at 110, that is used by various nodes and the CMS to communicate, and a persistent storage 130, usually a number of disk drives like an IBM 2107 storage system.

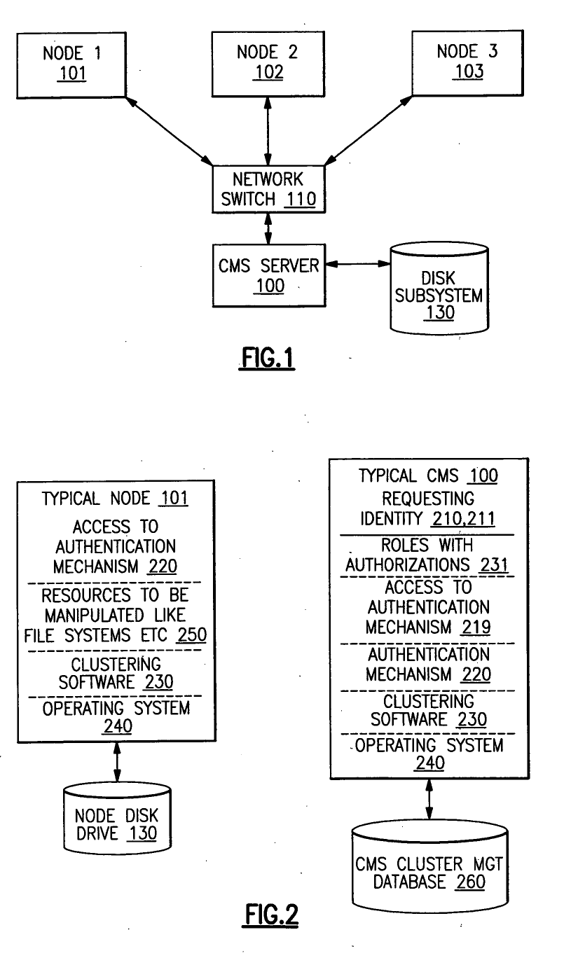

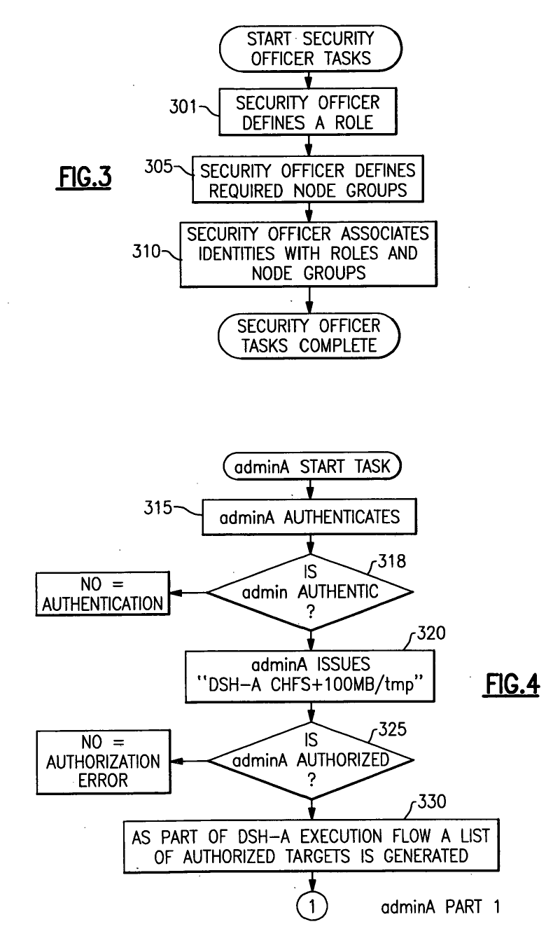

With reference to FIG. 2, a user or identity is represented at 210, 211, an example of which would be a UNIX user with a uid structure as defined by UNIX open group standards. An authentication mechanism like MIT Kerberos is represented at 220, and a set of roles, which are defined in the cluster as having the ability to perform one to N tasks, are represented at 231, 232. FIG. 2 also shows a remote execution mechanism that optionally executes against all defined nodes in the cluster. An example of a suitable remote execution mechanism is the IBM AIX CSM dsh command with the—a option that will execute a command as an argument and with the—a option will execute that command against all nodes defined in the cluster database 235.

FIG. 2 also represents Cluster management software, which preferably is the IBM Cluster System Manager feature of AIX 230, an operating system 240 on all servers, and a security officer or super privileged user identity 219. A set of resources that can be manipulated like a file system is represented at 250, and a cluster management database, which contains all the cluster definitions, is represented at 260.

In FIG. 1, Nodes 1, 2 and 3 101, 102, 103 communicate with the central management server 100 via the network switch 110. The central management server 100 stores and retrieves data from the persistent storage 130. The nodes 1, 2, 3 101, 102, 103 may or may not have persistent storage in a particular implementation. All nodes and the CMS server will have memory and at least one processor as would be found in a normal server or general-purpose computer.

In FIG. 2, the software stack on the left for the node 101 includes an operating system 240 that provides both privileged and non-privileged services, a layer of cluster management software 230 that provides clustering functions and the ability to receive tasks from the CMS 100, resources 250 that one to many cluster administrators may wish to manipulate, and access 220 to an authentication mechanism for purposes of validating the identity of a user or a task request from the CMS 100.

Also, in FIG. 2, the software stack on the right for the CSM 100 is the same as the node with the following additions. There is a task requesting identity, usually a cluster administrator with a given set of assigned roles, a persistent store of roles with associated authorizations 231, which is typically contained in the cluster management database 260, and optionally an authentication mechanism 220 like MIT Kerberos. It should be noted that this authentication mechanism can be and is typically located on a dedicated general-purpose computer that is network connected to the CSM 100.

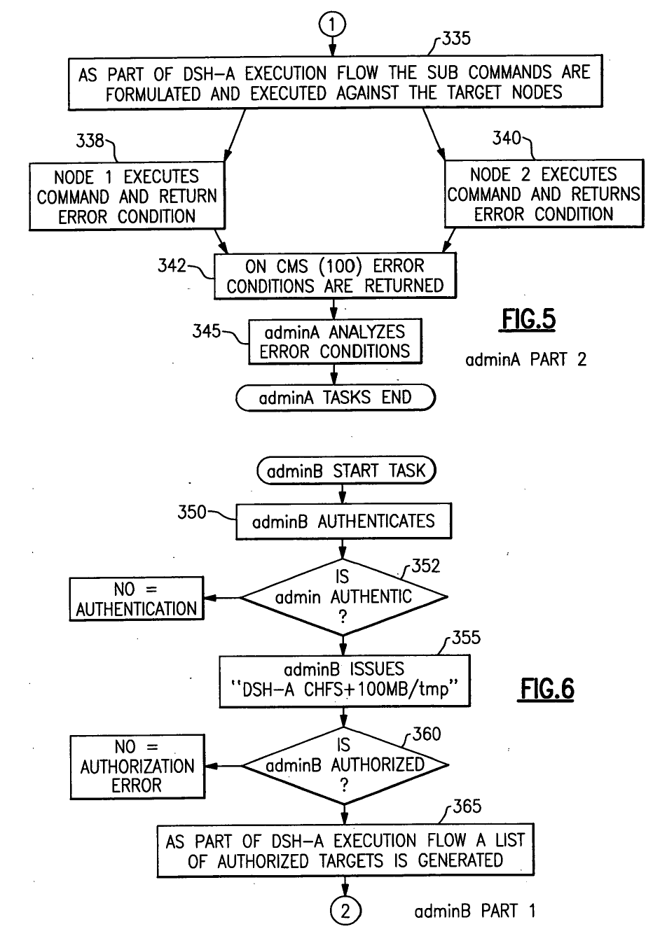

FIGS. 3-7 illustrate a procedure for implementing this invention. Generally, the illustrated procedure has two parts. In the first part, shown in FIG. 3, a security officer performs various tasks on the CMS 100; and in the second part, examples of which are shown in FIGS. 4-7, cluster administrators and the cluster management software carry out additional tasks to perform an authorization on identified targets.

More specifically, at step 301, on the CMS 100, a security officer 219 defines a role 231 that is made up of one to many authorizations and persistently stores this role. An example would be a file system administrator. At step 305, on the CMS (100), a security officer 219 defines several subsets of nodes in groups of one to many nodes and persistently stores this node group information. An example would be groupA=node 1 and node 2, and groupB=node 3. At step 310, on the CMS 100, a security officer associates the authorizations, node groups and user identities and persistently stores this association. An example would be user adminA has file system authorization for groupA (231) and user adminB has file system authorization for groupB (232).

With reference to FIG. 4, at step 315, on the CMS 100, a cluster administrator adminA authenticates themselves 210 with the authentication mechanism 220 to ensure the user has an authentic identity. As represented at step 320, on the CMS 100, the cluster administrator adminA (210) then can issue a command such as dsh—a chfs+100M/tmp 235. This command will increase the size of all /tmp file systems by 100 MB in the cluster that this identity has authorization for. In this case, Node 1 101 and Node 2 102.

At step 325, the cluster management software 230 as part of the dsh—a 235 execution flow, searches the cluster management database to determine if this identity can perform the requested authorization and returns an authorization error if not found. At step 330, software 230 also generates from the database the list of targets (nodes) that are associated with this authorization.

At step 335, shown in FIG. 5, the cluster management software 230, continuing as part of the dsh—a 235 execution flow, formulates the remote execution of the command and, as represented at 338 and 340, executes that command against the list of targets obtained in the prior step. At step 342, the target nodes then reply with either a successfully completed execution condition or an error condition; and at step 345, adminA analyzes any error condition information and then ends the task.

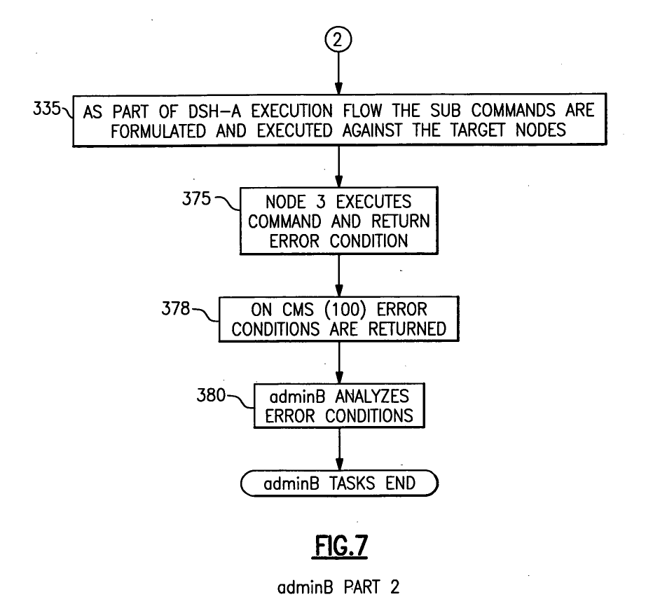

FIGS. 6 and 7 show tasks performed by AdminB. At step 350, on the CMS (100), a cluster administrator adminB authenticates themselves 211 with the authentication mechanism 220 to ensure the user has an authentic identity. At step 355, on the CMS 100, the cluster administrator adminB 211 then can issue a command such as dsh—a chfs+100M /tmp 235. This command will increase the size of all /tmp file systems by 100 MB in the cluster that this identity has authorization for. In this case, Node 3 103. At step 360, the cluster management software 230, as part of the dsh—a (235) execution flow, searches the cluster management database to determine if this identity can perform the requested authorization and returns an authorization error if not found. At step 365, this management software also generates from the database, the list of targets (nodes) that are associated with this authorization.

At step 370, the cluster management software 230, continuing as part of the dsh—a 235 execution flow, formulates the remote execution of the command and executes it against the list of targets obtained in the prior step. At step 375, the target nodes then reply with either a successfully completed execution condition or an error condition; and at step 380, adminB analyzes any error condition information and then ends the task.

An important advantage of the invention is that it allows server and network resource consumption to be reduced by executing a small number of commands, and it also saves cluster administrator labor time. To elaborate, in the current art, the chfs command (via the dsh—a) would be executed on all nodes (node 1, node 2 and node 3) by each cluster administrator with error return conditions being replied from the nodes that did not have an authorization for file system manipulation for the requesting identity on that node. Each cluster administrator would then have to review the output and determine which error returns were caused by the lack of authorization, which would be a false error in this case, and which error returns were actually valid.

In comparison, when the present invention is implemented, the chfs would only be executed on the nodes associated with that identity and authorization. The only error returns would be valid error returns. This invention thus allows server and network resource consumption to be reduced by executing a smaller number of commands.

The invention also saves cluster administrator labor time as they now only have to investigate valid error returns. No false positive error conditions are returned. The cluster administrators can now take further advantage of the dsh—a option. There is not a need for each administrator to create their own node groups to scope the execution of commands that are invoked by dsh—a. This invention also allows a security officer to limit the scope of individual cluster administrators and gives them the infrastructure to provide for a separation of duties. This invention also allows one central script for all administrators of a particular list of tasks to be used and all the administrators see the same behavior. This simplifies maintenance and reduces errors in change management processes.

It should be understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention can also be embodied in a computer program product, which comprises all the respective features enabling the implementation of the methods described herein, and which—when loaded in a computer system—is able to carry out these methods. Computer program, software program, program, or software, in the present context mean any expression, in any language, code or, notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art and it is intended that the appended claims cover all such modifications and embodiments as fall within the true spirit and scope of the present invention.

What is claimed is:

1. A method of defining roles in a distributed computing system having a set of nodes, the method comprising the steps of:
creating a defined role including one or more authorizations;
defining a plurality of subsets of the nodes;
associating each of a group of users with one of said authorizations and one of said subsets of nodes; and
storing in a database the authorization and said one of the subsets of nodes associated with said each user.

2. A method according to claim 1, comprising the further steps of:
one of said group of users initiating a task;
determining if said one of the users has authorization for said task; and
determining on which of the nodes said one of the users has authority for said task.

3. A method according to claim 2, comprising the further step of only executing said task on the nodes on which said one of the users has authority for said task.

4. A method according to claim 2, wherein the step of determining on which of the nodes said one of the users has authority for said task includes the step of looking in said database for a subset of nodes associated with said one of the users.

5. A method according to claim 4, comprising the further step of, if a subset of nodes associated with said one of the users is found in the database, only executing said task on the nodes in said found subset.

6. A method according to claim 1, wherein the distributed computing system includes a security officer, and the step of creating said defined role includes the step of using said security officer to create said defined role.

7. A system for defining roles in a distributed computing environment having a set of nodes, the system comprising:
means for creating a defined-role including one or more authorizations;
means for defining a plurality of subsets of the nodes;
means for associating each of a group of users with one of said authorizations and one of said subsets of nodes;
a database; and
means for storing in the database the authorization and said one of the subsets of nodes associated with each of said users.

8. A system according to claim 7, further comprising means for determining, when one of said group of users initiates a task, (i) if said one of the users has authorization for said task, and (ii) on which of the nodes said one of the users has authority for said task.

9. A system according to claim 7, further comprising means for executing said task only on the nodes on which said one of the users has authority for said task.

10. A system according to claim 7, wherein the determining means includes means for looking in said database for a subset of nodes associated with said one of the users.

11. A system according to claim 10, further comprising means for executing said task, if a subset of nodes associated with said one of the users is found in the database, only on the nodes in said found subset.

12. A system according to claim 7, wherein the means for creating said defined role includes a security officer.

13. A program storage device readable by machine, tangibly embodying a program of instructions executable by the machine to perform method steps for defining roles in a distributed computing system having a set of nodes, the method steps comprising:
creating a defined role including one or more authorizations;
defining a plurality of subsets of the nodes;
for each of a group of users, associating one of said authorizations and one of said subsets of nodes with said each user; and
storing in a database the authorization and said one of the subsets of nodes associated with said each user.

14. A program storage device according to claim 13,wherein said method steps further comprise:
enabling one of said group of users to initiate a task;
determining if said one of the users has authorization for said task; and
determining on which of the nodes said one of the users has authority for said task.

15. A program storage device according to claim 14, wherein said method steps further comprise the step of only executing said task on the nodes on which said one of the users has authority for said task.

16. A program storage device according to claim 14, wherein the step of determining on which of the nodes said one of the users has authority for said task includes the step of looking in said database for a subset of nodes associated with said one of the users.

17. A program storage device according to claim 16, wherein said method steps further comprise the step of, if a subset of nodes associated with said one of the users is found in the database, only executing said task on the nodes in said found subset.

18. A program storage device according to claim 13, wherein the distributed computing system includes a security officer, and the step of creating said defined role includes the step of using said security officer to create said defined role.
